(19) United States
(12) Patent Application Publication
(10) Pub. No.: US 2005/0152350 A1
(43) Pub. Date: Jul. 14, 2005

(54) System and method for transmitting/receiving automatic repeat request

(76) Inventors: Nak-Woon Sung, Daejeon-city (KR); Nam-Hoon Park, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/956,255

(22) Filed: Sep. 30, 2004

(30) Foreign Application Priority Data
May 19, 2004 (KR) 10-2004-0035543
Dec. 22, 2003 (KR) 10-2003-0095000

(51) Int. Cl. H04Q 11/00

(52) U.S. Cl. 370/376

(57) ABSTRACT

Disclosed are a system and method for transmitting/receiving an ARQ for correcting errors in an OFDM/TDMA terminal, and generating high-rate frames. The ARQ transmitting/receiving system of an OFDM/TDMA terminal comprises a CPU transmitting/receiving a data packet to/from an upper block in a software manner; an ARQ transmitting/receiving unit receiving the data packet, dividing the data packet into fragments each having a predetermined size, storing the fragments, generating a frame at the moment of generating a frame based on the stored fragment information, checking whether ARQ is retried or not, and transmitting/receiving the ARQ in a hardware manner; an interface buffer storing data transmitted between the CPU and the ARQ transmitting/receiving unit; and a fragment buffer storing fragments generated by the ARQ transmitting/receiving unit.

### CROSS REFERENCE TO RELATED APPLICATION

This application claims priority to and the benefit of Korea Patent Application No. 2003-95000 filed on Dec. 22, 2003 in the Korean Intellectual Property Office, the entire content of which is incorporated herein by reference.

### BACKGROUND OF THE INVENTION

(a) Field of the Invention

The present invention relates to a system and method for transmitting/receiving an automatic repeat request (ARQ). More specifically, the present invention relates to a system and method for transmitting/receiving an ARQ for correcting errors in radio data communication and generating high-rate frames in an OFDM/TDMA terminal.

(b) Description of the Related Art

A method of correcting errors generated in radio data communication when a frame is lost or damaged in the course of transmitting data includes a stop-and-wait ARQ method, a go-back-N continuous ARQ method, a selective-repeat continuous ARQ method, and a hybrid ARQ method. According to the stop-and-wait ARQ method, a transmitter transmits a single frame and then waits for an acknowledge message ACK. A receiver sends the acknowledge message ACK to the transmitter only when it receives the frame safely, and transmits a negative acknowledge message NAK when the frame has an error. If the receiver does not receive the frame because the frame is damaged, the receiver does not send any signal to the transmitter and the transmitter retransmits the frame after there is no signal transmitted thereto for a predetermined period of time. The stop-and-wait ARQ method is simple and easy, but its transmission efficiency is deteriorated due to a long waiting time.

In the go-back-N continuous ARQ method, a transmitter transmits a series of frames determined based on a window size. When a frame among the series of frames has an error, a receiver sends a NAK message with respect to the frame having the error to the transmitter and does not receive frames transmitted after the frame having the error. The transmitter retransmits all of frames after the NAK message.

The selective-repeat continuous ARQ method is a modified technique of the go-back-N continuous ARQ method that retransmits only frames for which the NAK message is received. Though the selective-repeat continuous ARQ method has high transmission efficiency, a memory space where frames following the frame having the error will be stored until the frame having the error is retransmitted is required, which may generate overhead.

A prior art is disclosed in Korea Patent Application No. 2000-71225 (filed on Nov. 28, 2000), entitled “High-speed data transmitter in mobile communication system and method of controlling the same”. This patent relates to a high-speed data transmitter and a method of controlling the transmitter for enabling reliable high-speed data transmission without deteriorating transmission rate, using a convolution coder and ARQ method. Specifically, this technique combines the convolution coder and ARQ method to mitigate a decrease in transmission rate and enable reliable data transmission such that the data transmitter can be applied to various high-speed communication systems including a CDMA system. Furthermore, the convolution coder of a conventional physical layer and the ARQ method of a link layer are combined to improve transmission rate and provide an error correction function.

Furthermore, PCT/IB2001/00618 discloses another ARQ technique entitled “Cooperation of ARQ protocol in physical layer and link layer for radio communication”. This technique improves a conventional protocol and algorithm to increase an error correction function and reduce overhead. Specifically, the technique improves an algorithm of providing automatic error recovery in a physical layer and link layer structure, to thereby provide a robust operation in a radio link and an ARQ function having a little additional overhead.

Moreover, Korea Patent Application No. 2002-49754 (filed on Aug. 22, 2002) discloses “ARQ transmitter, ARQ receiver and ARQ method”. This patent relates to a synchronous feedback transmission method capable of providing flexibility without having a shortcoming of an asynchronous transmission method, which is known to have high signaling overhead. Specifically, the patent reduces signaling overhead for transmitting ACK and NAK response messages in the asynchronous transmission method. A tail bit used in a forward error correction block even serves as a frame recognition number required in the ARQ method to reduce the quantity of overhead data. That is, the patent provides a transmitter, a receiver, and a method allowing flexible timing of ACK and NAK messages without having signaling overhead such that different kinds of receivers having long processing time and short processing time can be operated.

In the meantime, the aforementioned ARQ algorithm can be embodied in software or hardware. For example, a system such as WCDMA uses the selective-repeat continuous ARQ method, which is realized in software in an RLC layer. The ARQ algorithm is embodied in hardware in a system using a simple ARQ structure.

In the case where a mixed method of the selective-repeat continuous ARQ method and go-back-N continuous ARQ method is used in a high-speed OFDM/TDMA terminal, however, it is difficult to satisfy the timing requirement for generating frames when the ARQ algorithm is embodied in software. Although the receiver of the high-speed OFDM/TDMA terminal has a little timing requirement, it needs a lot of memory to be used for processing ARQ. Thus, the software ARQ algorithm can obtain many advantages.

Furthermore, the requirement for frame generation time given in the high-speed OFDM/TDMA terminal depends on a frame period. That is, the frame generation time is reduced as the operating speed of the OFDM/TDMA system is increased. In addition, the entire frame period can be divided into a downlink frame time and n uplink frame time. To receive and transmit data during the downlink frame time, information on an uplink frame should be extracted to generate the uplink frame in order to transmit the data. Here, the actual frame time a terminal can use is merely 1 to 3 ms, excepting transmission/reception time of a modem. The actual frame time becomes shorter as the operating speed of the system is increased. In this case, it is difficult to satisfy the timing requirement when the ARQ algorithm and a frame generator are constructed in software.

### SUMMARY OF THE INVENTION

An object of the present invention is to provide a system and method for transmitting/receiving an ARQ, which can satisfy a timing requirement of a high-speed OFDM/TDMA terminal for generating frames, and can generate high-rate frames to transmit high-rate data.

Another object of the present invention is to provide a system and method for transmitting/receiving an ARQ, which can be constructed in hardware inside an FPGA of an OFDM/TDMA terminal to provide an error correction function in radio data communication and a high-speed frame generating function.

Yet another object of the present invention is to provide a system and method for transmitting/receiving an ARQ, which can provide an error correction function in radio data communication, easily construct a receiving part that requires a little timing requirement, and reduce the quantity of memory capacity used in an FPGA or external hardware.

Still another object of the present invention is to provide a system and method for transmitting/receiving an ARQ, which can reduce excessive timer overhead when the selective-repeat continuous ARQ method is embodied in software.

In one aspect of the present invention, an ARQ transmitting/receiving system of an OFDM/TDMA terminal comprises a central processing unit transmitting/receiving a data packet to/from an upper block in a software manner; an ARQ transmitting/receiving unit receiving the data packet, dividing the data packet into fragments each having a predetermined size, storing the fragments, generating a frame at the moment of generating a frame based on the stored fragment information, checking whether ARQ is retried or not, and transmitting/receiving the ARQ in a hardware manner; an interface buffer storing data transmitted between the central processing unit and the ARQ transmitting/receiving unit; and a fragment buffer storing fragments generated by the ARQ transmitting/receiving unit.

Here, the data packet is a service data unit (SDU) that is received from the upper block and stored, or a protocol data unit (PDU) that is media-access-controlled.

The ARQ transmitting/receiving system can further comprise a frame buffer storing uplink frame data which will be transmitted from the terminal to a base station, and a downlink buffer storing downlink data transmitted from the base station to the terminal.

The central processing unit has a program storage unit including MAC transmitter software and MAC receiver software. The MAC transmitter software receives an SDU from the upper block and stores the SDU in the interface buffer. The MAC receiver software receives a PDU from the ARQ transmitting/receiving unit, and carries out ARQ reception and MAC PDU processing.

The ARQ transmitting/receiving unit includes a packet divider receiving the SDU from the central processing unit and dividing the SDU into fragments each having a fixed size; an address manager reporting the current state of the fragment buffer to a frame generator, a tail pointer of the address manager being updated by the packet divider whenever a new packet is stored in the fragment buffer, and a head pointer of the address manager being updated when the fragment buffer transmits data; the frame generator that is informed of information on the current fragment by the address manager and that generates a frame using the fragment information; a retry manager storing the fragment information, increasing a head pointer of the fragment buffer, moving fragment information that exceeds a time stamp value to a retry buffer, and discarding fragment information retried a predetermined number of times; a receiver block transmitting PDUs other than an ARQ response message among MAC PDUs received from the base station; and an ARQ response buffer receiving the ARQ response message from the receiver block, storing the ARQ response message, and transmitting the ARQ response message to the retry manager.

The ARQ transmitting/receiving system can further include a management message processing block that receives a management message for which fragmentation is not allowed from the central processing unit, stores the management message, and transmits the management message to the frame generator.

The frame generator is informed of information on the current management message by the management message processing block, and generates a frame using the information. In addition, the frame generator stores the generated frame in the frame buffer, and then transmits fragment information on ARQ traffic to the retry manager. Furthermore, the frame generator is constructed in hardware inside the FPGA, and generates a frame in a hardware manner using the fragment information.

The retry manager includes an ARQ buffer storing fragment information, and confirms whether each message stored in the ARQ buffer has been properly transmitted using an ARQ ACK message transmitted from the receiver block. In addition, the retry manager stores a transmission ARQ header having the address of the currently stored buffer and a stored time stamp value in the case of ARQ support traffic flow.

Here, the retry manager periodically searches the stored transmission ARQ header to update the time stamp value, and stores a transmission ARQ header having a time stamp value of more than the retry time in the retry buffer. Furthermore, when an ARQ response message is stored in the ARQ response buffer, the retry manager searches the transmission ARQ header buffer using the ARQ response message to check whether there is an ACK response, forwards a transmission window value according to an ARQ algorithm, and erases contents of the buffer.

The packet divider makes the address manager update a stored address value.

The address manager includes a circular queue whose tail pointer and head pointer are updated. In addition, the address manager does not store memory address values of more than 10 bits, and it uses a part of upper bits of the memory address values as the head pointer and tail pointer.

The transmitter software stores the SDU in the interface buffer located between the central processing unit and the ARQ transmitting/receiving unit before a frame generation request is generated.

In another aspect of the present invention, an ARQ transmitting/receiving method of an OFDM/TDMA terminal system comprises a) storing an SDU received from an upper block in a corresponding buffer; b) storing the SDU in an interface buffer when the corresponding buffer has sufficient capacity; c) judging whether a fragment buffer has sufficient capacity when an ARQ is enabled; d) dividing the SDU into fragments when the fragment buffer has sufficient capacity; e) storing the fragments in corresponding addresses and updating an address manager according to a variation in the addresses of the fragments; f) determining whether there is a request for generating a frame, and generating a frame; and g) transmitting/receiving the ARQ according to the frame.

Here, information on the fragments includes a sequence number, a time stamp, the number of times of retry, and a stored address.

The d) can comprise calculating a stored address pointer value, and dividing the SDU into fragments each having a fixed size.

The d) can further comprise inserting values about addresses where the fragments are stored into a queue designated by a tail pointer of a circular queue after the SDU is divided into the fragments; storing the values in the address manager; and fetching the fragments, starting from a head pointer of the circular queue, when a frame is requested to be generated.

The f) can comprise determining whether there is a frame generation request, and when there is a frame generation request, receiving current fragment information from the address manager and a retry manager; determining whether there is a fragment to be transmitted, fetching the fragment from the fragment buffer when there is a fragment to be transmitted, and generating a PDU packet; storing the fragment information in the retry manager; determining whether the fragment is stored in a retry buffer, and when the fragment is stored in the retry buffer, bringing fragment information from the retry buffer; and fetching the corresponding fragment from the fragment buffer to generate a PDU packet.

The f) can further comprise generating the frame in a hardware manner, and then storing information on a part of bits of the head pointer with respect to information on a frame that has been transmitted; periodically updating a time stamp value; when the frame information becomes more than a predetermined value, storing the frame information in the retry buffer again; and retransmitting fragments using the frame information when the frame is generated.

According to the present invention, the ARQ transmitting/receiving system includes the hardware frame generator, hardware ARQ transmitter, and software ARQ receiver. Data delivered to an upper block is transmitted, divided, and stored by hardware. The frame generator carries out ARQ processing after generating a frame. The software receiver transmits a PDU to an upper block such that a software processing block processes the PDU. Accordingly, an OFDM/TDMA terminal can generate a high-rate frame and provide an error correction function. In addition, the ARQ transmitting/receiving system can be easily constructed in a part having a little timing requirement.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 illustrates the structure of a frame of a conventional OFDM/TDMA system;

FIG. 2 illustrates the configuration of an OFDM/TDMA terminal including a hardware ARQ transmitter, a software ARQ receiver, and a hardware frame generator according to an embodiment of the present invention;

FIG. 3 illustrates the structure of software in a central processing unit including transmitter software and receiver software according to an embodiment of the present invention;

FIG. 4 illustrates the configuration of an FPGA including a hardware ARQ transmitter and a frame generator according to an embodiment of the present invention;

FIG. 5 illustrates management of a fragment buffer by a circular queue according to an embodiment of the present invention;

FIG. 6 illustrates internal processing routines of the hardware ARQ transmitter and frame generator according to an embodiment of the present invention; and

FIGS. 7a and 7b are flow charts showing a frame generating process according to an embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which similar descriptions are provided have the same reference numerals.

A system for transmitting/receiving an ARQ according to an embodiment of the present invention includes a hardware frame generator, a hardware ARQ transmitter, and a software ARQ receiver of an OFDM/TDMA terminal.

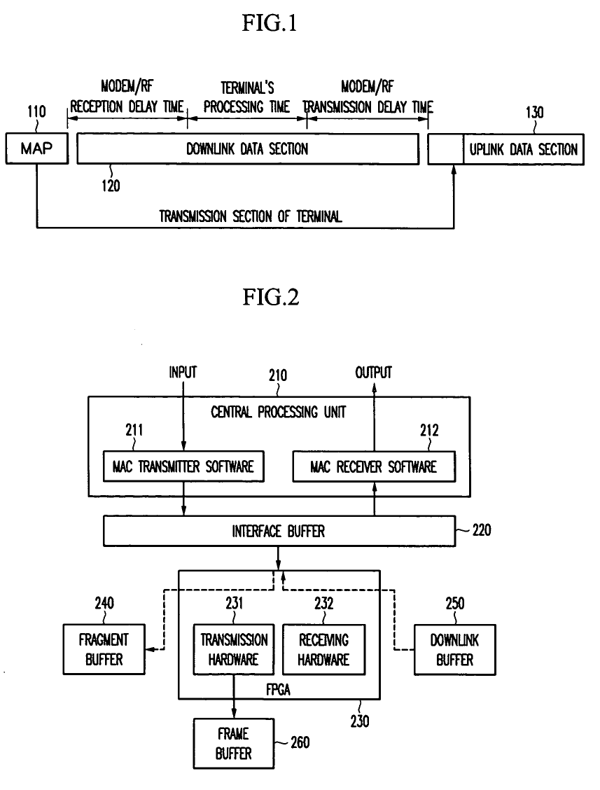

FIG. 1 illustrates the structure of a frame of a general OFDM/TDMA terminal. Referring to FIG. 1, the frame includes a MAP 110, a downlink data section 120, and an uplink data section 130. In the 802.16 OFDM/TDMA terminal, each frame is divided into the uplink section 130 and downlink section 120. A base station transmits data through the downlink section 120. Each terminal recognizes data corresponding thereto from downlink map data placed before each section, and receives the data.

A terminal that is to transmit data to the base station confirms whether there is a bandwidth allocated thereto using uplink map data. When there is a bandwidth allocated to the terminal, the terminal can transmit a frame in an allocated section. Here, the entire frame period is divided into a downlink section and an uplink section. The downlink section is longer than the uplink section due to asymmetry of the most general web data. However, the period of the frame transmitted from the terminal to the base station becomes shorter as the operating speed of the OFDM/TDMA system is increased.

In the OFDM/TDMA system, the terminal requests the base station to allocate a bandwidth whenever the terminal has data to transmit, and the terminal can transmit data within a range allowed by the base station.

The uplink timing requirement is difficult to achieve because information on allocation of a bandwidth to each terminal can only be known after each downlink frame is received and after uplink map data including information on an uplink frame is received. Accordingly, the frame period is in units of ms in a high-speed TDMA system, and a period of time required for recognizing the frame structure, generating a frame conforming to the structure, and transmitting the frame is very short.

In the case where the above-described TDMA system is constructed in software, it is more difficult to satisfy the timing requirement as the operating speed of the TDMA system is increased. This is because a long period of time is required for transmitting/receiving data to/from a central processing unit and an external I/O device including an external memory. Accordingly, data can be transmitted at a higher rate if the data is downloaded to hardware before a frame generation request is sent to the system.

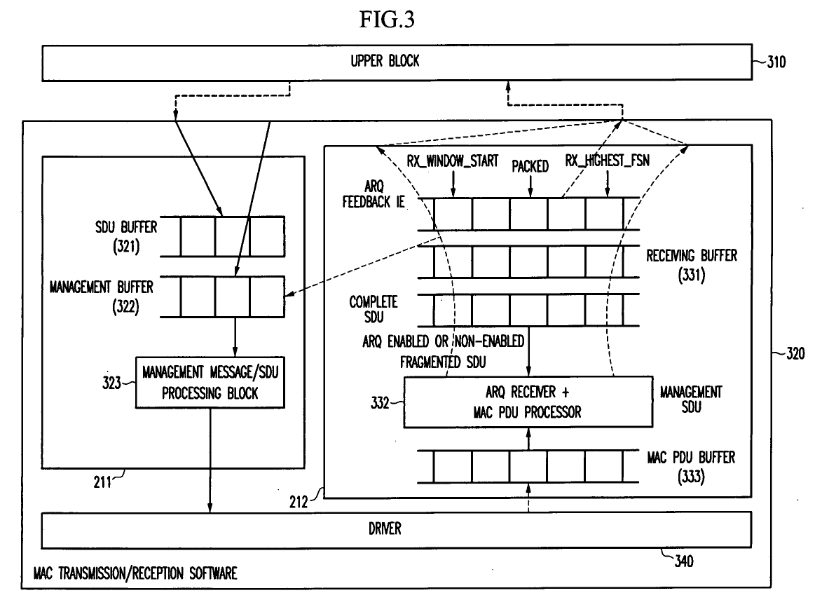

FIG. 2 illustrates the configuration of an OFDM/TDMA terminal including a hardware ARQ transmitter, a software ARQ receiver, and a hardware frame generator according to an embodiment of the present invention. Referring to FIG. 2, the ARQ transmitting/receiving system according to the present invention includes a central processing unit 210, a field programmable gate array (FPGA) 230, an interface buffer 220, a fragment buffer 240, a frame buffer 260, and a downlink buffer 250. The central processing unit 210 transmits/receives a data packet to/from an upper block in a software manner. The FPGA 230 receives the data packet, divides the data packet into fragments each having a predetermined size, and stores the fragments. In addition, the FPGA 230 generates a frame at the instant of generating the frame based on information on the stored fragments, checks whether an ARQ is retried or not, and transmits/receives the ARQ in a hardware manner. The interface buffer 220 stores data transmitted between the central processing unit 210 and the FPGA 230. The fragment buffer 240 stores the fragments generated in the FPGA 230. The frame buffer 260 stores uplink frame data which will be transmitted from a terminal to a base station. The downlink buffer 250 stores downlink data transmitted from the base station to the terminal.

Here, the data packet can be a service data unit (SDU) that is transmitted from the upper block and stored, or a protocol data unit (PDU) that is media-access-controlled.

The central processing unit 210 has a program storage unit including media access control (MAC) transmitter software 211 and MAC receiver software 212. The MAC transmitter software 211 receives an SDU from the upper block, and stores the received SDU in the interface buffer 220. The MAC receiver software 212 receives a PDU from the FPGA 230 to receive the ARQ and media-access-control the PDU.

As shown in FIG. 2, the ARQ transmitting/receiving system according to the embodiment of the present invention can be designed such that the system is divided into a hardware part and a software part in consideration of a timing requirement and memory requirement of a high-speed TDMA system, and ease of constructing the system.

A transmitting side includes a hardware part for transmitting user data and a software part for transmitting data delivered from an upper layer to the hardware part before a frame is generated. A receiving side processes most functions by software, and processes simple processing by hardware because the timing requirement of the receiving side is not so strict.

To easily process data in the hardware, all the data transmitted to the hardware is divided into fragments, each having a predetermined size, and is stored in a separate fragment buffer 240. Here, an uplink frame which will be transmitted from the terminal to the base station is stored in the frame buffer 260. In general, a datagram is capsulated in a physical network frame to be transmitted. The maximum length of a single frame that can be transmitted on a physical network is called a maximum transmission unit (MTU) of the network. Since physical networks have different MTUs, a large datagam should be divided to suit a network having the smallest MTU to be transmitted. The divided datagrams are fragments each of which has a fragment header.

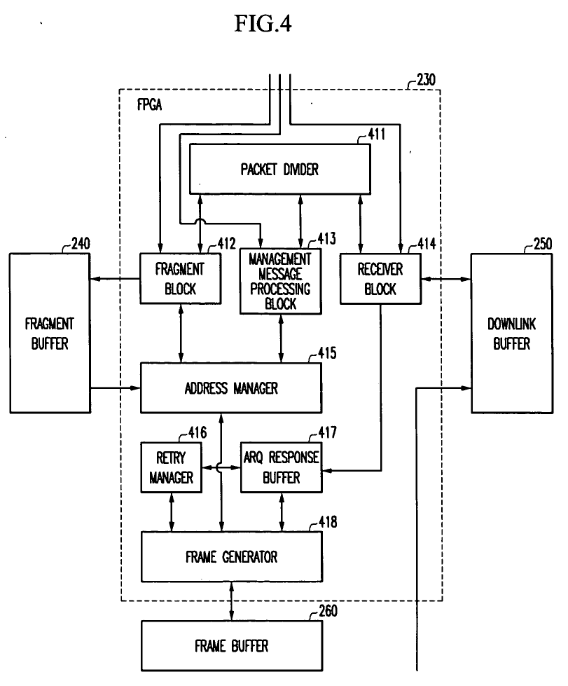

FIG. 3 illustrates the structure of software in the central processing unit including transmitter software and receiver software according to an embodiment of the present invention. For convenience of explanation, the software structure is considered to be constructed by a program including software, a buffer, and a processor.

Referring to FIGS. 2 and 3, the processing operation of an ARQ receiver conforms to a general ARQ algorithm, so a detailed explanation thereof will be omitted.

MAC transmission/reception software 320 shown in FIG. 3 consists of the MAC transmitter software 211, MAC receiver software 212, and a driver 340. The MAC transmitter software 211 can include an SDU buffer 321, a management buffer 322, and a management message/SDU processing block 323. The MAC transmitter software 211 carries out only operations of storing data transmitted from an upper block 310 in the interface buffer 220 located between the central processing unit 210 and FPGA 230, and informing the FPGA 230 that the data is stored in the interface buffer 220. That is, the transmitter software 211 simply transmits the data received from the upper block to the hardware before a frame is generated, as described above. Though the transmitter software 211 stores the SDU in the interface buffer 220 before a frame generation request is generated, the SDU is divided into fragments in the hardware manner.

The MAC receiver software 212 includes a receiving buffer 331, an ARQ receiver, a MAC PDU processor 332, and a MAC PDU buffer 333. As described above, the software part of the receiving side processes most of the functions, and its hardware part processes only simple processing because the timing requirement of the receiving side is not so strict.

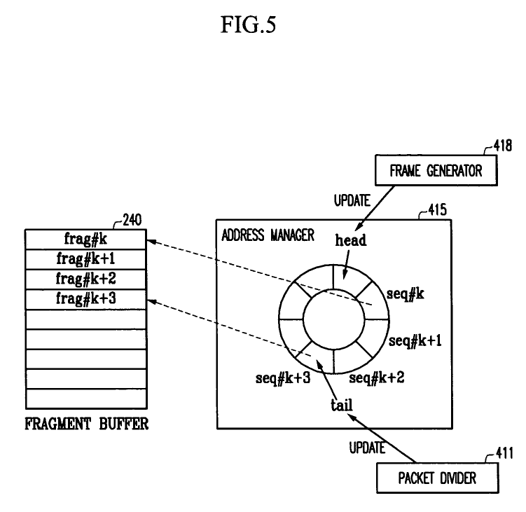

FIG. 4 illustrates the configuration of the FPGA including a hardware ARQ transmitter and a frame generator according to an embodiment of the present invention. The ARQ transmitter and receiver according to an embodiment of the present invention are constructed in hardware inside the FPGA 230.

Referring to FIG. 4, the FPGA 230 includes the hardware transmitter and frame generator 418. A data packet is stored in the interface buffer 220 located between the central processing unit 210 and FPGA 230, which can be accessed by a packet divider 411 before the moment of time of generating the current frame. The stored data packet is divided by the packet divider 411 into fragments, each having a predetermined size, which are stored in the fragment buffer 240. Here, a subheader including a sequence number and a fragment length is generated and stored in the fragment buffer 240.

The frame generator 418 accepts a frame generation request and receives information of data that can be currently transmitted through an address manager 415 and a management message processing block 413 to generate a frame.

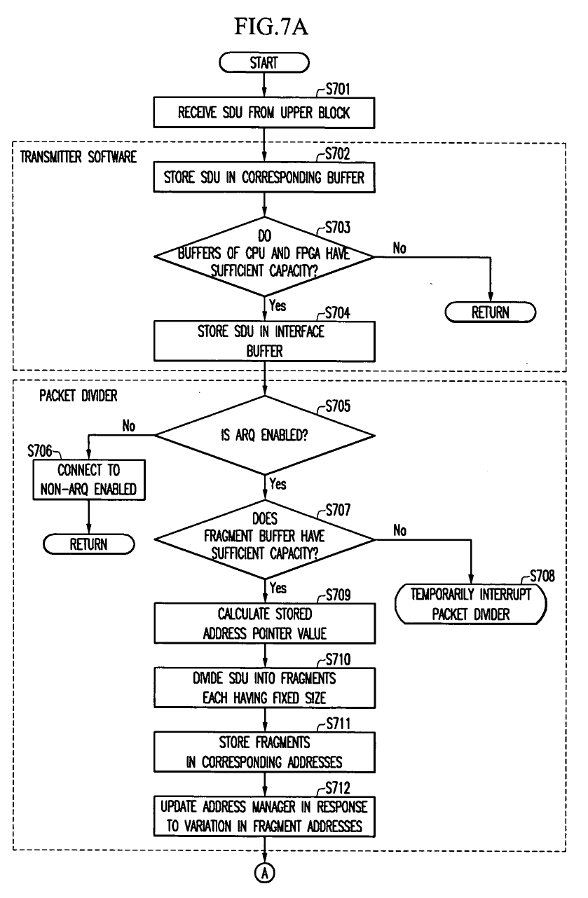

A traffic receiver of a receiver block 414 receives an ARQ response message, stores the received ARQ response message in an ARQ buffer 416-1 (shown in FIG. 6), and informs a retry manager 416 that the ARQ response message is stored in the ARQ buffer. Here, the retry manager 416 periodically searches transmission ARQ headers stored in the ARQ buffer 416-1 to update a time stamp value, and when there is a transmission ARQ header having a time stamp value of more than the retry time, moves this transmission ARQ header to a retry buffer 417-1 (shown in FIG. 6).

When an ARQ response message is stored in an ARQ response buffer 417, the retry manager 416 searches headers in the ARQ buffer using the ARQ response message to check whether there is an ARQ response. For a fragment for which an acknowledge signal ACK has been received, the retry manager 416 erases the header of the corresponding fragment from the ARQ buffer and transmits the result to the address manager 415 to update an address management pointer, that is, a head pointer, with respect to the fragment buffer 240.

Specifically, the FPGA 230 according to the present invention includes the packet divider 411, fragment block 412, management message processing block 413, receiver block 414, address manager 415, retry manager 416, ARQ response buffer 417, and frame generator 418, as shown in FIG. 4.

The packet divider 411 receives an SDU from the central processing unit 210, and divides the SDU into fragments, each having a fixed size. Here, the packet divider 411 makes the address manager 415 update a stored address value. The packet divider 411 updates a tail pointer of the address manager 415 whenever a new packet is stored in the fragment buffer 240. The address manager 415 reports the current state of the fragment buffer to the frame generator 418. The frame generator updates a head pointer of the address manager 415 when the fragment buffer 240 transmits data.

The address manger 415 includes a circular queue having the tail pointer and heater pointer, which are updated. Furthermore, the address manager 415 does not store memory address values of more than 10 bits, and uses a part of the upper bits of the memory address values as the head pointer and tail pointer.

The frame generator 418 receives information on current fragments from the address manager 415, and generates a frame using the fragment information. The frame generator 418 stores the generated frame in the frame buffer, and then transmits fragment information on ARQ traffic to the retry manager 416. The frame generator 418 is constructed in hardware inside the FPGA 430, and it generates a frame in a hardware manner using the fragment information. Preferably, the fragment information is a sequence number, a time stamp, the number of times of retry, or a stored address.

The retry manager 416 stores the fragment information and increases a head pointer of the fragment buffer 240. In addition, the retry manager 416 moves fragment information that exceeds a time stamp value to the retry buffer 417-1, and discards fragment information retransmitted a predetermined number of times. Furthermore, the retry manager 416 includes the ARQ buffer 416-1 storing fragment information. The retry manager 416 confirms whether each message in the ARQ buffer 416-1 has been properly transmitted using an ARQ ACK message delivered from the receiver block 414.

Moreover, the retry manager 416 stores a transmission ARQ header having the address of a currently stored buffer and a stored time stamp value in the ARQ buffer 416-1 in the case of ARQ support traffic flow. The retry manager 416 periodically searches the stored transmission ARQ header to update the time stamp value, and stores a transmission ARQ header having a time stamp value longer than the retry time in the retry buffer 417-1.

When an ARQ response message is stored in the ARQ response buffer 417, the retry manager 416 searches the ARQ header buffer to check whether there is an ACK response using the ARQ response message. Then, the retry manager 416 forwards a transmission window value according to the ARQ algorithm and erases contents of a corresponding buffer.

The receiver block 414 transmits PDUs other than the ARQ response message among MAC PDUs received from the base station to the central processing unit 210. That is, the traffic receiver of the receiver block 414 transmits data packets other than the ARQ response message to the central processing unit 210. The MAC receiver software 212 that receives the ARQ and processes MAC PDU combines fragments according to the ARQ algorithm to transmit the combined fragment to the upper block 310.

The ARQ response buffer 417 receives the ARQ response message from the receiver block 414, stores the ARQ response message, and then transmits the ARQ response message to the retry manager 416.

The management message processing block 413 receives a management message for which fragmentation is not allowed from the central processing unit 210, stores the management message, and transmits the management message to the frame generator 418. Here, the frame generator 418 receives information on the current management message from the management message processing block 413 and generates a frame using the information.

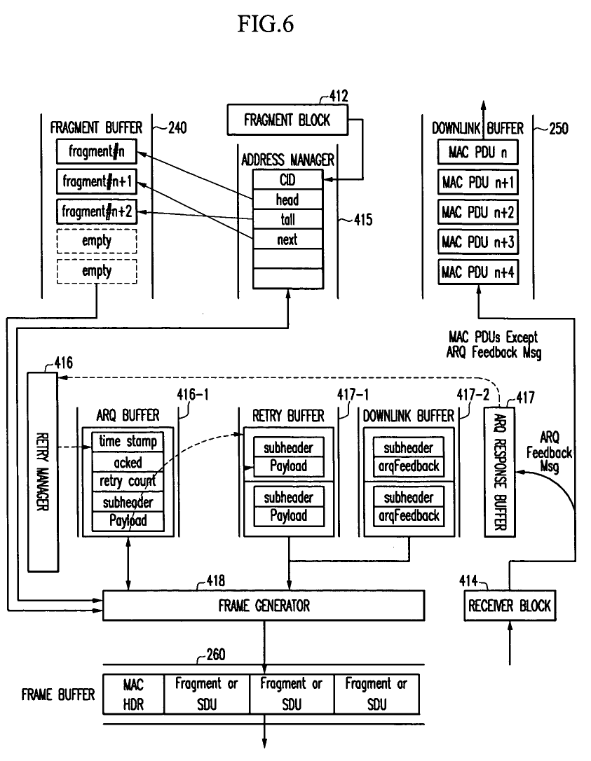

FIG. 5 illustrates management of the fragment buffer by the circular queue according to the embodiment of the present invention. The packet divider 411, address manager 415, and frame generator 418 are involved in the management of the fragment buffer 240. Here, the fragment buffer 240 is managed using the circular queue.

Referring to FIG. 5, the fragment buffer 240 should be stably accessed by the packet divider 411 and frame generator 418 simultaneously. Furthermore, the fragment buffer 240 should have integrity in terms of memory management. That is, the fragment generator 418 and a fragment consumer should be considered to have the same memory management address. For this, a circular queue memory management is required.

As shown in FIG. 5, the packet divider 411 receives data from the central processing unit 210, divides the data into fragments, each having a predetermined size, and stores the fragments. In addition, the packet divider 411 updates only the tail pointer of the address manager 415.

The frame generator 418 consumes fragments, starting from the head pointer, in order to generate a frame, and transmits the result to the address manager 415 to update the head pointer. Since the head pointer is updated only by the frame generator 418 and the tail pointer is updated only by the packet divider 411, memory consistency can be maintained in the fragment buffer 240.

FIG. 6 illustrates internal processing routines of the hardware ARQ transmitter and frame generator according to the embodiment of the present invention. FIG. 6 shows that the retry manager 416 stores and manages a header having minimum information on a corresponding fragment, not all of the currently transmitted fragments, in order to reduce the quantity of memory consumed for the ARQ processing.

First of all, the frame generator 418 transmits a fragment of the fragment buffer 240, and then delivers information on the transmission of the fragment to the retry manager 416. The retry manager 416 receives a current time stamp value and sequence number with respect to the transmitted fragment, and a stored address value with respect to the fragment buffer 240 from the frame generator 418, and stores and manages them.

After the retry manager 416 stores the stored address value, the retry manager 416 periodically increases the time stamp value and transmits fragment information that has become more than a predetermined value from the ARQ buffer 416-1 to the retry buffer 417-1.

The frame generator 418 generates a frame with reference to the contents of the retry buffer 417-1 of the retry manager 416, as well as information from the address manager 416. Information on the retry buffer 417-1, which has been transmitted, is stored in the ARQ buffer 416-1 of the retry manager 416 again. Here, a retry count value is increased, and when the retry count value is larger than a predetermined value, the retry count value is discarded.

The receiver block 414 transmits ARQ feedback information to the ARQ response buffer 417, and sends MAC PDU information other than the ARQ feedback information to the uplink buffer 250.

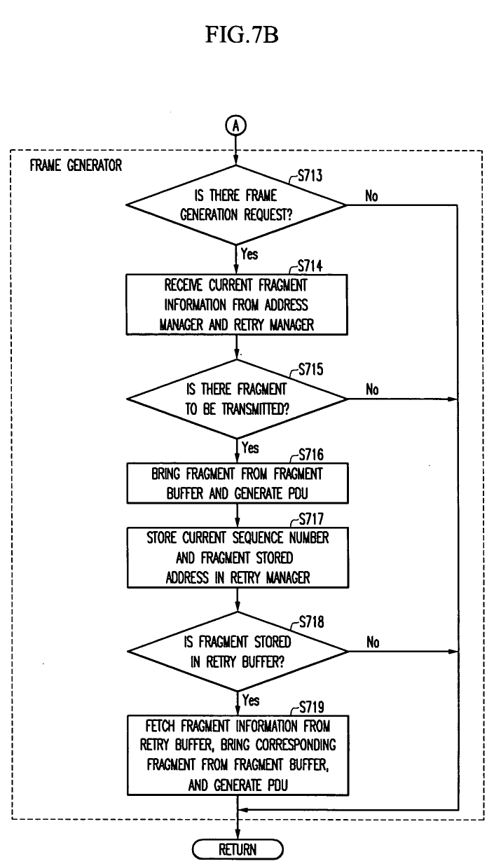

FIGS. 7a and 7b are flow charts showing a process of generating a frame having the aforementioned structure according to an embodiment of the present invention. The frame generating process includes a process in the transmitter software 211, a process in the packet divider 411, and a process in the frame generator 418.

Referring to FIG. 7a, the transmitter software 211 receives an SUD from an upper block in step S701, and stores the SDU in the SDU buffer 321 in step S702. Then, the transmitter software 211 determines whether buffers in the CPU 210 and FPGA 230 have sufficient capacity in step S703. When the buffers have sufficient capacity, the transmitter software 211 stores the SDU in the interface buffer 220 in step S704.

Next, the packet divider 411 determines whether the ARQ is enabled or not in step S705. The packet divider 411 connects to a non-ARQ enabled state in step S706 when the ARQ is not enabled, and determines that the fragment buffer 240 has sufficient capacity in step S707 when the ARQ is enabled. If the fragment buffer 240 does not have sufficient capacity, the packet divider 411 is temporarily interrupted in step S708.

When the fragment buffer 240 has sufficient capacity, the packet divider 411 calculates a stored address pointer value in step S709 and divides the SDU into fragments, each having a fixed size in step S710. Then, the packet divider 411 stores the fragments in corresponding addresses in step S711, and updates the address manager 415 based on variations in fragment addresses in step S712.

Referring to FIG. 7b, the frame generator 418 determines whether there is a frame generation request in step S713. When there is a frame generation request, the frame generator 418 receives current fragment information from the address manager 415 and retry manager 416 in step S714. Then, the frame generator 418 determines whether there is a fragment to be transmitted in step S715. When there is a fragment, the frame generator 418 brings the fragment from the fragment buffer 240 and generates a PDU packet in step S716.

Next, the frame generator 418 stores the current sequence number and fragment stored address in the retry manager 416 in step S717. Then, the frame generator 418 determines whether the fragment is stored in the retry buffer 417-1 in step S718. When the fragment is stored in the retry buffer 417-1, the frame generator 418 brings fragment information from the retry buffer 417-1, fetches the fragment from the fragment buffer 240, and generates a PDU packet, in step S719.

As described above, the present invention can easily construct the frame generator 418 and ARQ transmitter 231 in hardware, and construct the PDU processor and ARQ receiver 332 in software, to generate high-rate frames.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

According to the present invention, an OFDM/TDMA terminal with an operating speed of less than several ms can generate uplink frames at a high speed. Furthermore, the ARQ transmitter for error correction is constructed in hardware, and not only initially transmitted frames but also retried frames are processed by hardware so that high-rate frames can be generated. Moreover, the ARQ transmitter can be maintained with a small quantity of memory capacity. In addition, the ARQ receiver is constructed in software to reduce the quantity of memory used for the receiving part in the FPGA.

1. An ARQ (automatic repeat request) transmitting/receiving system of an OFDM/TDMA terminal, comprising:
a central processing unit transmitting/receiving a data packet to/from an upper block in a software manner;
an ARQ transmitting/receiving unit receiving the data packet, dividing the data packet into fragments each having a predetermined size, storing the fragments, generating a frame at the moment of generating a frame based on the stored fragment information, checking whether ARQ is retried or not, and transmitting/receiving the ARQ in a hardware manner;
an interface buffer storing data transmitted between the central processing unit and the ARQ transmitting/receiving unit; and
a fragment buffer storing fragments generated by the ARQ transmitting/receiving unit.

2. The ARQ transmitting/receiving system as claimed in claim 1, wherein the data packet is a service data unit (SDU) that is received from the upper block and stored, or a protocol data unit (PDU) that is media-access-controlled.

3. The ARQ transmitting/receiving system as claimed in claim 1, further comprising a frame buffer storing uplink frame data which will be transmitted from the terminal to a base station.

4. The ARQ transmitting/receiving system as claimed in claim 1, further comprising a downlink buffer storing downlink data transmitted from the base station to the terminal.

5. The ARQ transmitting/receiving system as claimed in claim 1, wherein the central processing unit has a program storage unit including MAC transmitter software and MAC receiver software, the MAC transmitter software receiving an SDU from the upper block and storing the SDU in the interface buffer, and the MAC receiver software receiving a PDU from the ARQ transmitting/receiving unit and carrying out ARQ reception and MAC PDU processing.

6. The ARQ transmitting/receiving system as claimed in claim 1, wherein the ARQ transmitting/receiving unit comprises:
a packet divider receiving the SDU from the central processing unit and dividing the SDU into fragments each having a fixed size;
an address manager reporting the current state of the fragment buffer to a frame generator, a tail pointer of the address manager being updated by the packet divider whenever a new packet is stored in the fragment buffer, and a head pointer of the address manager being updated when the fragment buffer transmits data;
the frame generator that is informed of information on the current fragment by the address manager and generates a frame using the fragment information;
a retry manager storing the fragment information, increasing a head pointer of the fragment buffer, moving fragment information that exceeds a time stamp value to a retry buffer, and discarding fragment information retried a predetermined number of times;
a receiver block transmitting PDUs other than an ARQ response message among MAC PDUs received from the base station; and
an ARQ response buffer receiving the ARQ response message from the receiver block, storing the ARQ response message, and transmitting the ARQ response message to the retry manager.

7. The ARQ transmitting/receiving system as claimed in claim 6, further comprising a management message processing block that receives a management message for which fragmentation is not allowed from the central processing unit, stores the management message, and transmits the management message to the frame generator.

8. The ARQ transmitting/receiving system as claimed in claim 7, wherein the frame generator is informed of information on the current management message by the management message processing block and generates a frame using the information.

9. The ARQ transmitting/receiving system as claimed in claim 6, wherein the frame generator stores the generated frame in the frame buffer, and then transmits fragment information on ARQ traffic to the retry manager.

10. The ARQ transmitting/receiving system as claimed in claim 6, wherein the retry manager includes an ARQ buffer storing fragment information.

11. The ARQ transmitting/receiving system as claimed in claim 10, wherein the retry manager confirms whether each message stored in the ARQ buffer has been properly transmitted using an ARQ ACK message transmitted from the receiver block.

12. The ARQ transmitting/receiving system as claimed in claim 6, wherein the retry manager stores a transmission ARQ header having the address of the currently stored buffer and a stored time stamp value in the case of ARQ support traffic flow.

13. The ARQ transmitting/receiving system as claimed in claim 12, wherein the retry manager periodically searches the stored transmission ARQ header to update the time stamp value and stores a transmission ARQ header having a time stamp value of more than a retry time in the retry buffer.

14. The ARQ transmitting/receiving system as claimed in claim 12, wherein, when an ARQ response message is stored in the ARQ response buffer, the retry manager searches the transmission ARQ header buffer using the ARQ response message to check whether there is an ACK response, forwards a transmission window value according to an ARQ algorithm, and erases contents of the buffer.

15. The ARQ transmitting/receiving system as claimed in claim 6, wherein the packet divider makes the address manager update a stored address value.

16. The ARQ transmitting/receiving system as claimed in claim 6, wherein the address manager includes a circular queue whose tail pointer and head pointer are updated.

17. The ARQ transmitting/receiving system as claimed in claim 16, wherein the address manager uses a part of upper bits of the memory address values as the head pointer and tail pointer without storing memory address values of more than 10 bits.

18. The ARQ transmitting/receiving system as claimed in claim 5, wherein the transmitter software stores the SDU in the interface buffer located between the central processing unit and the ARQ transmitting/receiving unit before a frame generation request is generated.

19. An ARQ transmitting/receiving method of an OFDM/TDMA terminal system, comprising:
a) storing an SDU received from an upper block in a corresponding buffer;
b) storing the SDU in an interface buffer when the corresponding buffer has sufficient capacity;
c) determining whether a fragment buffer has sufficient capacity when an ARQ is enabled;
d) dividing the SDU into fragments when the fragment buffer has sufficient capacity;
e) storing the fragments in corresponding addresses and updating an address manager according to a variation in the addresses of the fragments;
f) determining whether there is a frame generation request and generating a frame; and
g) transmitting/receiving the ARQ according to the frame.

20. The ARQ transmitting/receiving method as claimed in claim 19, wherein information on the fragments includes a sequence number, a time stamp, the number of times of retry, and a stored address.

21. The ARQ transmitting/receiving method as claimed in claim 19, wherein the d) comprises calculating a stored address pointer value, and dividing the SDU into fragments each having a fixed size.

22. The ARQ transmitting/receiving method as claimed in claim 21, wherein the d) further comprises:
inserting values about addresses where the fragments are stored into a queue designated by a tail pointer of a circular queue after the SDU is divided into the fragments;
storing the values in the address manager; and
fetching the fragments, starting from a head pointer of the circular queue, when there is a frame generation.

23. The ARQ transmitting/receiving method as claimed in claim 19, wherein the f) comprises:
determining whether there is a frame generation request, and when there is a frame generation request, receiving current fragment information from the address manager and a retry manager;
determining whether there is a fragment to be transmitted, fetching the fragment from the fragment buffer when there is a fragment to be transmitted, and generating a PDU packet;
storing the fragment information in the retry manager;
determining whether the fragment is stored in a retry buffer, and when the fragment is stored in the retry buffer, bringing fragment information from the retry buffer; and
fetching the corresponding fragment from the fragment buffer to generate a PDU packet.

24. The ARQ transmitting/receiving method as claimed in claim 19, wherein the f) further comprises:
generating the frame in a hardware manner, and then storing information on a part of bits of the head pointer with respect to information on a frame that has been transmitted;
periodically updating a time stamp value;
when the frame information becomes more than a predetermined value, storing the frame information in the retry buffer again; and
retrying fragments using the frame information when the frame is generated.

25. The ARQ transmitting/receiving method as claimed in claim 19, further comprising:
receiving an ARQ response message from a base station;
transmitting the ARQ response message to the retry manager;
deleting fragment information for which an acknowledge message has been received; and
updating fragment addresses in the address manager.
